(19) United States
(12) Patent Application Publication
(10) Pub. No.: US 2008/0148309 A1
(43) Pub. Date: Jun. 19, 2008

(54) AUDIENCE MEASUREMENT SYSTEM AND MONITORING DEVICES

(75) Inventors: Peter Wilcox, Gerrards Cross (GB); Mark Adrian Wheatley, Maidenhead (GB)

Correspondence Address: BANNER & WITCOFF, LTD., TEN SOUTH WACKER DRIVE, SUITE 3000, CHICAGO, IL, 60606, US

(73) Assignee: TAYLOR NELSON SOFRES PLC, London (GB)

(21) Appl. No.: 11/669,686

(22) Filed: Jan. 31, 2007

(30) Foreign Application Priority Data
Dec. 13, 2006 (EP) 06025826.6

(51) Int. Cl. H04N 7/173

(52) U.S. Cl. 725/14

(57) ABSTRACT

Audience measurement systems having fixed and portable monitoring devices are provided. Embodiments of the audience measurement system may be suitable for monitoring programs viewed and/or listened to by one or more members of a sample household. The fixed monitoring device may be associated with a particular media device, for example, in the household's home and monitor a received broadcast signal and/or a state of the media device to extract information enabling a received program and/or station to be identified. The portable monitoring device may comprise a receiver for receiving sound of a program emitted by any nearby media device; a data extractor for extracting data from the received sound to enable a program and/or station to be identified. Either a first or a second communicator may be operable to transmit a device present signal in the vicinity of its respective monitoring device, and/or detect the said signal.

### FIELD OF THE INVENTION

The invention relates to an audience measurement system, an audience measurement method, and fixed and portable monitoring devices for use in such an audience measurement system and method. Embodiments of the audience measurement system are suitable for monitoring programs viewed and/or listened to by one or more members of a sample household.

### BACKGROUND

Audience measurement systems are designed to obtain viewing figure data for broadcast programs, such as television programs and radio programs, including advertisements. Such data is of considerable importance to broadcasters and advertisers who wish to know the number of viewers viewing their programs and the demographic breakdown of those viewers.

One known method of obtaining such data involves selecting a sample of households whose members are demographically representative of the population as a whole, and requiring the members of the sample households to record their viewing habits in a diary. This method is inconvenient for the members and is unreliable as it is prone to human error. For example, members do not always remember to fill in the diary, or they fill it in incorrectly at a later time. In addition, only a limited amount of data about the programs received may be obtained without requiring too great an effort on the part of the members.

In order to mitigate the above problems, two alternative audience measurement systems are known. The first of these systems involves the installation of fixed monitoring devices in the homes of the selected sample households. Each fixed monitoring device is typically associated with a fixed television set, and automatically determines the use made of the television set, such as whether the set is turned on or off and what channel the set is tuned to. Household members manually record that they are watching television, usually by pressing buttons on a remote control, so that it may be determined which household members watched which programs.

The fixed monitoring devices may use a variety of techniques for determining what is being watched and may provide very detailed information about precisely what was watched, including details of interactive services used.

One basic technique is to detect the frequency to which the television set is tuned, so as to determine the channel watched, and to subsequently determine the programs viewed by comparing the times at which particular channels were watched with broadcast schedules for those channels obtained from the broadcasters or compiled at a reference monitoring site monitoring the output of the channels.

A second technique is to detect ancillary codes inserted by the broadcasters into the programs received, the codes uniquely identifying the channel and/or program received. Usually the codes identify the channel but not the program, in which case it is again necessary to refer to the broadcast schedules.

A third technique is to extract characteristic signatures from the received programs, and to compare the extracted signatures with signatures contained in a reference library or obtained at a reference monitoring site.

Fixed monitoring devices are not well suited to monitoring the use of portable media devices such as small portable television sets and video playback devices. In addition, when using fixed monitoring devices it is necessary to record the viewing by guests in a sample member's home as a surrogate for the viewing by the sample member that takes place in other homes. It is assumed that guests have the same demographic profile as their hosts, but it is still necessary to record their age and sex. This may be inconvenient for the sample members.

The second alternative audience measurement system uses portable monitoring devices. These devices monitor the exposure of individual sample members to television and/or radio. Each individual carries a monitoring device which typically has an integral microphone. The microphone picks up sounds to which the individual is exposed, whether in the individual's home, the home of a friend or relative or in a public place such as a shop or bar. The device analyses the audio signals received to determine which, if any, broadcast the individual is exposed to. This analysis may be based on code detection or signature extraction from the received signals. The portable monitoring device is capable of detecting exposure to portable television sets and radios and may be adapted to monitor such devices when headsets are used.

It may be determined whether the exposure occurs in the individual's own home or elsewhere, for example by using a short-range radio beacon transmitter in the home and a receiver in the portable monitoring device. Reception of the signal from the transmitter indicates presence in the home. As a result of detecting the individual's exposure to broadcasts both inside and outside his home there is no need to monitor guests who watch television in the individual's home.

Portable monitoring devices cannot give very detailed information about what is being watched. For example, being typically based on analyzing the audio signal they cannot determine when video-only aspects of television viewing change, such as the use of drop-down menus, text or graphic overlays or other interactive services.

It is therefore desirable to provide an audience measurement system which enables detailed information about the programs being watched or listened to be determined.

It is further desirable to provide an audience measurement system which minimizes the burden on the sample members and which can thus provide accurate information about the programs viewed and/or listened to.

### BRIEF SUMMARY

According to a first aspect of the invention, there is provided an audience measurement system for monitoring programs viewed and/or listened to by one or more members of a sample household. One exemplary system comprises a fixed monitoring device and a portable monitoring device, wherein: the fixed monitoring device is associated with a particular media device, in the household's home, which is operable to receive broadcast programs, and comprises a monitoring mechanism for monitoring a received broadcast signal and/or a state of the media device to extract information enabling a received program and/or station to be identified; and a first communicator for communicating with the portable monitoring device; and wherein the portable monitoring device, which may be carried by a user, comprises a receiver for receiving sound of a program emitted by a nearby media device; a data extractor for extracting data from the received sound to enable a program and/or station to be identified; and a second communicator for communicating with the fixed monitoring device; wherein either the first or the second communicator is operable to transmit a device present signal in the vicinity of its respective monitoring device, and the second or the first communicator is operable to detect the said signal, such that the second or first communicator is operable to detect when the portable monitoring device is in the vicinity of the fixed monitoring device.

Advantageously, the audience measurement system is able to obtain detailed information about the exposure of the sample member to broadcasts in the member's home and to obtain data about the member's exposure to broadcasts outside of the member's home.

Furthermore, by provision of the communicator for communicating a device present signal between the fixed monitoring device and the portable monitoring device, it may be determined when the member is in the vicinity of the fixed monitoring device. Advantageously, this makes it unnecessary for the member to press buttons on a remote control to indicate his presence to the fixed monitoring mechanism. Thus, the burden on the member is minimized. In this regard, it is perceived that requiring a sample member to both press buttons to indicate his presence when watching television at home and to carry a portable monitoring device at all (or all other) times would be too demanding a task and would lead to a poor compliance rate.

According to an embodiment of the system, the first or second communicator is operable to transmit device identifying information as at least a part of the device identifying signal.

According to another embodiment, the first or second communicator is arranged to transmit the audio signal, or a signal derived therefrom, of the received broadcast signal or of the received sound, respectively, as at least a part of the device present signal, and the second or first communicator is arranged to receive the said audio signal or signal derived therefrom.

According to still another embodiment, the portable monitoring device or the fixed monitoring device further includes a comparator for comparing the audio signal, or the signal derived therefrom, received from the first or second communicator with the audio signal of its received program sound or received broadcast signal, respectively, to determine whether the audio signals correspond.

Advantageously, by comparing the audio signals received by both of the portable monitoring device and the fixed monitoring device it may be accurately determined whether the portable monitoring device is exposed to essentially the same audio as the fixed monitoring device, i.e. whether the member is viewing/listening to the media device monitored by the fixed monitoring device.

The comparison performed by the comparing means may be based, for example, on codes (such as critical band encoding technology (CBET) codes) embedded in the audio signals or on audio signatures extracted from the audio signals. In addition, it may be based on the timing of events which occur in the audio signals.

On certain embodiments, the comparator is operable to perform the comparison only when it is determined that the portable monitoring device is in the vicinity of the fixed monitoring device and that the particular media device monitored by the fixed monitoring device is switched on. In this way, battery and memory usage in the portable monitoring device may be reduced.

In another embodiment, the monitoring mechanism of the fixed monitoring device or the data extractor of the portable monitoring device is further arranged to extract data from the audio signal, or signal derived therefrom, received from the other of the monitoring devices. The extracted data may be stored in memory means for comparison later, or may be compared using the comparing means.

The data extractor of the portable monitoring device may include a signature extractor for extracting signatures from the audio signal of the received sound, or a code extractor for extracting an embedded code from the said audio signal, or both. In addition, it may include an event timing detector for detecting the timing of an event in the audio signal.

The monitoring mechanism of the fixed monitoring device may include a signature extractor, a code extractor, a media device tuning detector for detecting a frequency to which the media device is tuned, or a combination of these. In addition, it may include an event timing detector for detecting the timing of an event in the audio signal.

According to a second aspect of the invention, there is provided an audience measurement method for monitoring programs viewed and/or listened to by a member of a sample household using a fixed monitoring device associated with a particular media device in the member's home and a portable monitoring device which may be carried by the member, the method comprising: monitoring a received broadcast signal and/or a state of the particular media device, using the fixed monitoring device, to extract information enabling a received program and/or station to be identified; receiving sound of a program emitted by any nearby media device using the portable monitoring device; extracting data from the received sound to enable a received program and/or station to be identified; transmitting a device present signal from the fixed monitoring device or the portable monitoring device in the vicinity of the monitoring device; detecting the device present signal at the other of the fixed monitoring device and the portable monitoring device so as to detect when the portable monitoring device is in the vicinity of the fixed monitoring device.

According to an embodiment, the device present signal includes device identifying information.

According to a further embodiment, the device present signal includes the audio signal, or a signal derived therefrom, of the received broadcast signal or of the received sound.

The method may further include extracting a code from the device present signal when the device present signal is detected, and/or extracting a signature from the device present signal when the device present signal is detected.

In another embodiment, the received broadcast signal is monitored by extracting a code from the signal, and/or extracting a signature from the signal, and/or detecting a frequency to which the particular media device is tuned.

In a further embodiment, the extracting data from the received sound includes extracting a code embedded in the audio signal of the received sound and/or extracting a signature from the audio signal of the received sound.

In a still further embodiment, the method further comprises comparing, at the other of the fixed monitoring device and the portable monitoring device, the audio signal, or the signal derived therefrom, with the audio signal of the received broadcast signal or of the received program sound, respectively.

The comparison may be performed using codes extracted from the audio signals. The codes may be critical band encoding technology (CBET) codes. Alternatively, the comparison may be performed using signatures extracted from the audio signals. Also, the comparison may be performed using the timings of events detected in the audio signals.

According to a third aspect of the invention, there is provided a fixed monitoring device for use in an audience measurement system for monitoring programs viewed and/or listened to by one or more members of a sample household, the fixed monitoring device being associated with a particular media device, in the household's home, which is operable to receive broadcast programs, wherein the fixed monitoring device comprises: a monitoring mechanism for monitoring a received broadcast signal and/or a state of the media device to extract information enabling a received program and/or station to be identified; and a communicator for transmitting a device present signal in the vicinity of the fixed monitoring device, the device present signal being receivable by a portable monitoring device.

The monitoring mechanism may include at least one of a code extractor for extracting a code from the received broadcast signal, a signature extractor for extracting a signature from the received broadcast signal, a media device tuning detector for detecting a frequency to which the media device is tuned, and an event timing detector for detecting the timing of events in the audio signal of the received broadcast signal.

The communicator may be operable to transmit device identifying information as at least a part of the device present signal.

Furthermore, the communicator may be operable to transmit the audio signal, or a signal derived therefrom, of the received broadcast signal, as at least a part of the device present signal.

According to a fourth aspect of the invention, there is provided a portable monitoring device for use in an audience measurement system for monitoring programs viewed and/or listened to by one or more members of a sample household, the portable monitoring device comprising: a receiver for receiving sound of a program emitted by a nearby media device; a data extractor for extracting data from the received sound to enable a program and/or station to be identified; and a communicator for detecting a device present signal from a fixed monitoring device when the portable monitoring device is in the vicinity of the fixed monitoring device.

The device may further comprise a comparator for comparing an audio signal of the device present signal with an audio signal of the received sound, so as to determine whether the portable monitoring device is exposed to substantially the same program as the fixed monitoring device.

In addition, the portable monitoring device may be operable to determine from the received device present signal whether a media device associated with the fixed monitoring device is switched on, and to control the comparator to perform the comparison only when it is determined that the said media device is switched on.

Still furthermore, the portable monitoring device may be operable to control the comparator to cease performing the comparison if it is determined that the device is in the vicinity of the fixed monitoring device and the data extractor is extracting data from the received sound.

The data extractor may include one or both of a code extractor for extracting a code from the audio signal of the received sound and a signature extractor for extracting a signature from the audio signal of the received sound. Instead of, or in addition to, a signature extractor, the data extractor may include an event timing detector for detecting the timing of events in the audio signal of the received sound.

### BRIEF DESCRIPTION OF THE DRAWINGS

FIG. 1 is a schematic diagram of a broadcast and monitoring system in which broadcast signals are transmitted from broadcasters to households and in which data concerning the viewing habits of sample ones of the households is monitored;

FIG. 2 is a schematic diagram of a fixed monitoring device according to an embodiment of the invention;

FIG. 3 is a schematic diagram of a portable monitoring device according to an embodiment of the invention;

FIG. 4 is a schematic diagram of a portable monitoring device according to another embodiment of the invention;

FIG. 5 is a schematic diagram of a fixed monitoring device according to another embodiment of the invention;

FIG. 6 is a schematic diagram of a portable monitoring device according to another embodiment of the invention;

FIG. 7 is a schematic diagram of a fixed monitoring device according to another embodiment of the invention;

FIG. 8 is a schematic diagram of a portable monitoring device according to another embodiment of the invention.

### DETAILED DESCRIPTION

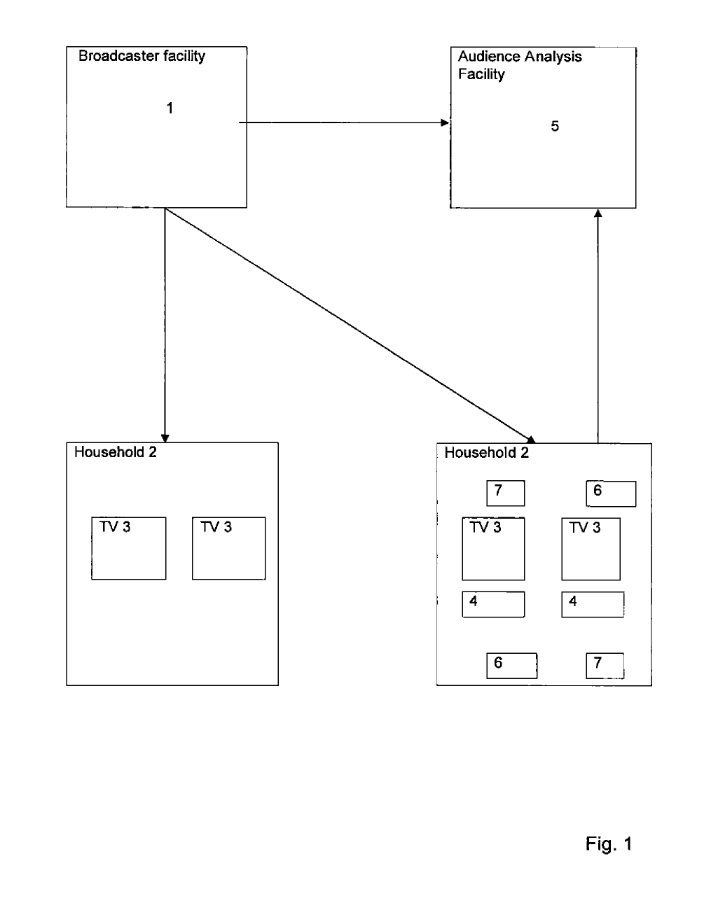

FIG. 1 is a schematic diagram of a broadcast and monitoring system in which broadcast signals are transmitted from a broadcaster facility 1 to households 2 and in which data concerning the viewing habits of a sample one of the households is monitored at an audience analysis site 5. Multiple channel program services are broadcast from the broadcaster facility 1, for example by digital cable and/or satellite, and are received at the households 2, for example by television/set top boxes 3. Of course, many households are part of the system, FIG. 1 showing only two households for simplicity.

In one of the households 2, the viewing habits of the members of the household are monitored by an audience measurement system, so as to obtain viewing figure data of the programs watched. Fixed monitoring devices 4 are provided in the monitored household 2, each fixed monitoring device being associated with a particular television/set top box 3. The fixed monitoring devices obtain data about the programs viewed and interactive services used by the members of the household and transmit this data to the audience analysis site 5, where the data may be analyzed. Data may be transmitted to the audience measurement site 5 via a telephone line, and may be transmitted live or at set intervals, for example once per day. Alternatively, the data may be returned to the broadcaster facilities 1 via a return path, such as a back channel of the cable system or a telephone line, and forwarded from the broadcaster facilities to the audience analysis site 5.

A plurality of portable monitoring devices 6, each carried by a respective member of the household, are provided in the monitored household also. The portable monitoring devices monitor the programs to which each member of the household is exposed. Data from the portable monitoring devices 6 may be transmitted to the audience analysis site 5 via base stations 7 of the portable monitoring devices or via the fixed monitoring devices. The data may be transmitted from the base stations over a telephone line, for example. The portable monitoring devices may be re-charged by being placed at their respective base stations, for example overnight when the members of the household are asleep.

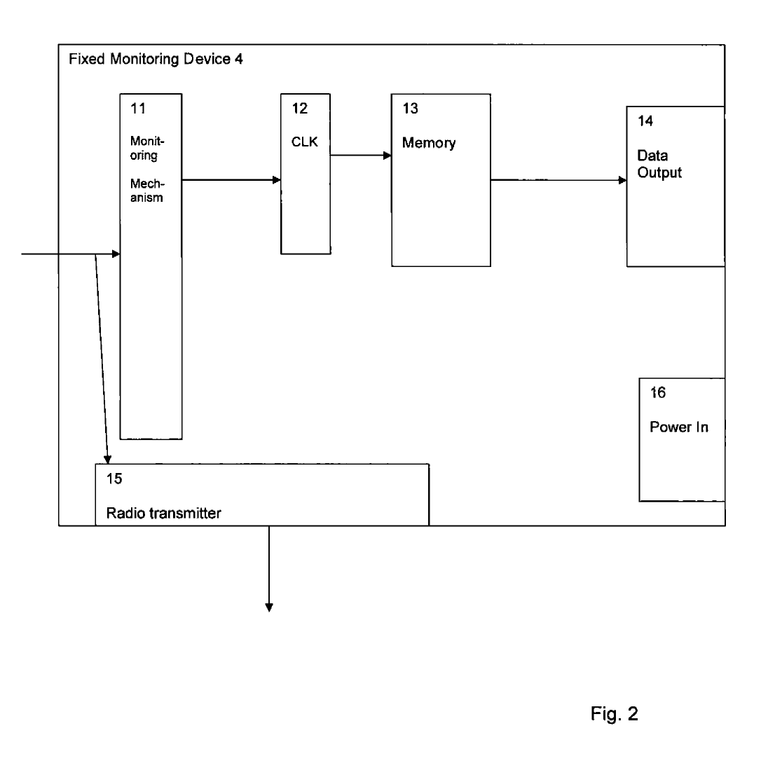

FIG. 2 shows schematically a configuration of a fixed monitoring device 4 according to an embodiment of the invention. The device includes a monitoring mechanism 11 for monitoring a broadcast signal received by the television/set top box 3 and/or a state of the television/set top box 3. The monitoring mechanism 11 extracts information enabling the programs and/or channels viewed on the television to be determined. The monitoring mechanism is connected to a clock 12, which is operable to time stamp the program and/or channel information obtained by the monitoring mechanism so that it may be determined at what times different programs and/or channels were watched. The clock 12 is connected to memory 13, in which the time-stamped program/channel information is stored. The data stored in the memory 13 is transmitted via the data output 14 to the audience analysis site 5, perhaps via the broadcaster facility 1. The data output 14 may be a telecommunications processor such as a modem for transmitting the viewing data via the telephone line or a transmitter for transmitting the viewing data via a back channel of the cable system.

The data may be transmitted from the data output 14 continuously, or may be transmitted at regular intervals, for example once each day. If the data is transmitted continuously, the size of the memory 13 may be reduced such that it retains only a limited amount of data for retransmission in the event of a fault in the transmission.

The monitoring mechanism 11 includes either or both of a code extractor for extracting codes embedded in the broadcast signal received by the television/set top box 3 and a signature extractor for extracting characteristic signatures from the received broadcast signal. It also includes a mechanism for determining whether the television 3 is on or off.

Code extractors are known and are employed in current fixed monitoring devices. A code may, for example, be embedded in the vertical blanking interval of the transmitted signal, or be embedded in the audio signal of the broadcast signal. In this regard, the code may be a Critical Band Encoding Technology (CBET) code, which is a code inaudible to humans embedded in the audio signal. Such codes and code extractors are disclosed in U.S. Pat. Nos. 5,7647,63 and 5,450,490, which are hereby incorporated by reference in their entirety. Currently used codes typically identify the broadcaster (source, i.e. channel) of the broadcast signal and are inserted by the broadcasters at the broadcaster facility 1. The time stamped codes transmitted from the data output 14 of the fixed monitoring device 4 may be compared at the audience analysis site 5 to broadcast schedules obtained from the broadcasters or compiled at the audience analysis site 5 to determine the particular programs viewed.

Signature extractors are also known. These extract characteristic signatures from the received broadcast signal, for example by sampling the audio signal at predetermined times or after predetermined events occur in the broadcast signal, such as abrupt scene changes indicating channel changes. Signatures and signature extraction are disclosed in U.S. Pat. Nos. 4,677,466 and 4,697,209, the entire contents of which are incorporated herein by reference in their entirety. The time-stamped extracted signatures transmitted from the data output 14 of the fixed monitoring device 4 may be compared to reference signatures extracted contemporaneously from broadcasts by reference signature extractors at the audience analysis site 5 or stored in a reference library at the audience analysis site. In this way, the particular programs viewed may be determined.

The fixed monitoring device further includes a communicator 15 for communicating with the portable monitoring device 6, in the present embodiment a short-range radio transmitter for transmitting a device present signal in the vicinity of (e.g. within the room or household of) the fixed monitoring device which may be received by the portable monitoring device 6. In the present embodiment, the device present signal includes data identifying the fixed monitoring device 4, i.e. data identifying which television 3 in the sample household the fixed monitoring device is associated with. The device present signal also includes the audio signal of the received broadcast signal.

The fixed monitoring device also includes a power input 16, by which the device may be powered from the mains supply. Alternatively, the fixed monitoring device may be battery powered.

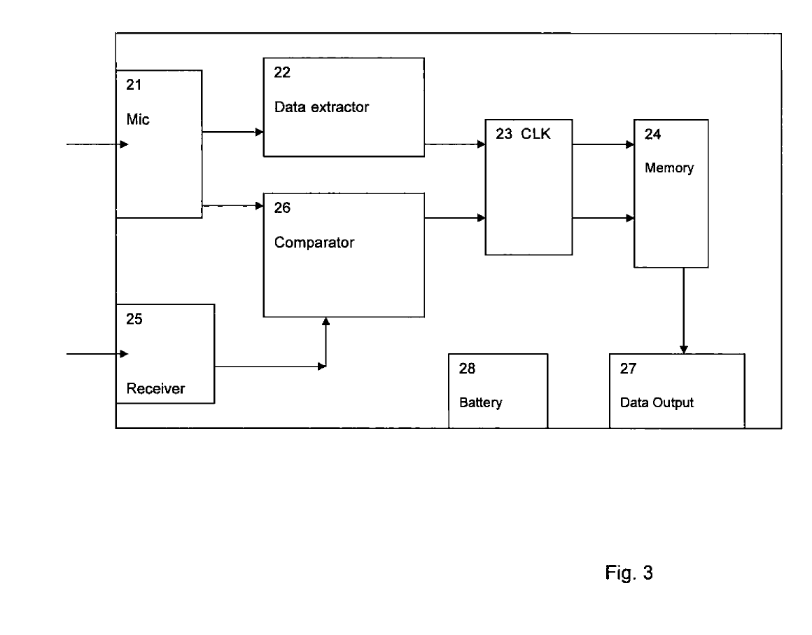

FIG. 3 shows an embodiment of a portable monitoring device for use with the fixed monitoring device of FIG. 2. The portable monitoring device includes a microphone 21 acting as a receiver for receiving sounds emitted by nearby media devices such as televisions and radios, a data extractor 22 for extracting data from the audio signals of the received sounds to enable the programs and/or stations of the received sounds to be identified, a clock 23 for time stamping the extracted data and a memory 24 for storing the extracted time-stamped data. The portable monitoring device is powered by a battery 28. In addition, the portable monitoring device includes a radio antenna 25 acting as a communicator for receiving the device present signal from the fixed monitoring device 4 and a comparator 25 for comparing the audio signal of the device present signal with the audio signal of the received sound by audio matching, for example by comparing the frequencies or amplitudes of the signals. If there is correspondence between the two audio signals, it may be determined that the portable monitoring device is exposed to essentially the same audio as the fixed monitoring device. The output of the comparator is stored in the memory 24.

The data stored in the memory 24 may be uploaded to the portable monitoring device's base station 7, for example by means of a physical attachment, wirelessly or using a removable memory card. Alternatively, the data may be uploaded to the fixed monitoring device 4.

The data extractor 22 for extracting data from the received sound may include a code extractor or a signature extractor or both. If the fixed monitoring device 4 includes a code extractor, then the portable monitoring device 6 may also include a code extractor. Alternatively, if the fixed monitoring device 4 includes a signature extractor, then the portable monitoring device 6 may include a signature extractor. If the fixed monitoring device 4 includes both, then the portable monitoring device may include either. The code extractor extracts codes embedded in the audio signal, such as CBET codes. These codes identify the program and/or station received. Usually the codes identify the station received, in which case the program received may be determined at the audience analysis site 5 by comparing the time-stamped codes transmitted from the portable monitoring device 6 with a broadcast schedule.

The signature extractor extracts characteristic signatures from the audio signal. These may be samples of the audio signal taken at regular intervals or samples taken when predetermined events (cues) occur. Such cues include, for example, abrupt changes in the audio signal indicating a change of channel received. The extracted time-stamped characteristic signatures may be compared with signatures extracted from broadcast programs by reference signature extractors at the audience analysis site 5 to determine the programs received.

The extracted signatures may also be compared with reference signatures stored in a reference signature library at the audience analysis site 5. In this way, the programs received by the sample member may be identified even if they are not broadcast programs. For example, if the sample member is viewing a film played back on a video playback device, or listening to recorded music, the signatures stored in the reference signature library may be used to identify the film or music. In this regard, the portable memory device may include an input socket for receiving an input lead split (forked) from the lead of a headphone set, such that the device may be used to monitor audio material listened to by the sample member even when wearing headphones.

Using the above described fixed monitoring device 4 of FIG. 2 and the portable monitoring device 6 of FIG. 3, the programs to which the sample member is exposed may be monitored irrespective of whether they are broadcast programs received in the home (for example at a television set), pre-recorded programs played back on a video or music playback device (whether in the home or elsewhere) or broadcast programs which the sample member is exposed to outside of the home, such as when listening to the radio in the car, or viewing television at a friend's home or in a bar.

Furthermore, detailed information, for example concerning the use of interactive services, may be obtained when the user is viewing programs in his home, without placing any increased burden on the user. The user simply wears the portable monitoring device at all times and takes no action with respect to the fixed monitoring device.

When the user is in the vicinity of the fixed monitoring device, the radio receiver 25 of the portable monitoring device 6 receives the device present signal from the fixed monitoring device 4, and circuitry in the receiver identifies the fixed monitoring device from the identifying information in the device present signal. In addition, the comparator 26 compares the audio signal contained within the device present signal with the audio signal received from the microphone 21. Thus, it is determined whether or not the member is exposed to essentially the same audio as is being received by the nearby fixed monitoring device. When it is determined that the member is exposed to essentially the same audio this is recorded in the memory 24. Therefore, when the data from the portable monitoring device and the fixed monitoring device is analyzed at the audience monitoring site 5, it may be seen that at a particular time the member was exposed to the same programs as were being received on the television 3 associated with a particular fixed monitoring device 4. The more detailed information extracted by the fixed monitoring device, for example concerning the use of interactive services such as drop-down menus and graphic overlays, may then be associated with the particular sample member wearing the corresponding portable monitoring device 6. In other words, it may readily be determined which of the members of the sample household was watching the television 3 associated with the fixed monitoring device 4 without any input from the sample members themselves.

In a preferred configuration of the portable monitoring device 6, the circuitry of the receiver 25 determines from the device present signal the identity of any fixed monitoring devices 4 in the vicinity and whether or not the televisions 3 associated with the respective fixed monitoring devices are switched on or off (this information being included in the device present signal). If all of the televisions 3 associated with the fixed monitoring devices 4 are switched off, then the comparator is made to discontinue the comparison process. In this way, power consumption and memory usage may be reduced.

In a further preferred configuration of the portable monitoring device 6, if the circuitry of the receiver 25 receives one or more device present signals indicating that the portable monitoring device is in the vicinity of one or more fixed monitoring devices 4, and determines from the signals that a television 3 associated with at least one of the fixed monitoring devices is switched on, and if the code extractor and/or signature extractor 22 of the portable monitoring device is extracting codes (e.g. CBET codes) or signatures from the sound received by microphone 21, then the comparator 26 may be made to discontinue the comparison process.

In this way, power consumption and memory usage may be reduced. The exposure of the portable monitoring device 6 (and hence member wearing it) to the programs received by a television 3 associated with a fixed monitoring device 4 may still be determined by later comparison at the audience analysis site 5 between the time-stamped codes and/or signatures extracted by the code and/or signature extractors 22 of the portable monitoring device and the corresponding time-stamped codes and/or signatures extracted by the monitoring mechanism 11 of the fixed monitoring devices 4. In particular, the pattern of channel changing over time recorded by the time-stamped codes or signatures will enable it to be determined that the portable monitoring device was exposed to the same programs as the fixed television 3 monitored by the fixed monitoring devices 4. This may also be the case if two televisions monitored by different fixed monitoring devices receive the same program at the same time, as subsequent patterns of channel changes will usually enable it to be determined which of the monitored televisions the portable monitoring device was exposed to.

Alternatively, if the portable monitoring device 6 determines from received device present signals that it is in the vicinity of one or more fixed monitoring devices 4 and that the television 3 associated with at least one of those fixed monitoring devices is switched on, it may perform the comparison process using comparator 26 to determine whether the audio signal received from any of the fixed monitoring devices 4 matches the audio signal received by its microphone 21. If the audio signal from one of the fixed monitoring devices matches the audio signal received by microphone 21, the portable monitoring device 6 may continue to perform the comparison process but may discontinue the data extraction (code or signature extraction) performed by the data extraction means 22. The data extraction is discontinued until the audio signals compared by the comparator no longer match, at which point data extraction is resumed.

In this way, the exposure of the portable monitoring device 6 (and hence member wearing it) to the programs received by a television 3 associated with a fixed monitoring device 4 may be determined subsequently at the audience analysis site 5 from the data transmitted from the portable monitoring device 6 which indicates that the device was in the vicinity of the fixed monitoring device 4 and was receiving the same audio signal as the fixed monitoring device 4. The detailed information on the sample member's use of the television extracted by the fixed monitoring device 4 may then be linked to the sample member.

As a further alternative, the fixed monitoring device 4 may be configured such that if it detects codes and/or signatures in the audio signal of the received broadcast signal using its monitoring mechanism 11, it ceases to broadcast the audio from its short-range radio transmitter 15. This has the advantage of reducing occupancy of the radio spectrum. A portable monitoring device 6 in the vicinity of the fixed monitoring device 4 is thus unable to perform the comparison process using the comparator 26, but continues to extract codes and/or signatures from the audio signal received by its microphone 21. The exposure of the portable monitoring device 6 to the programs received by a television 3 associated with a fixed monitoring device 4 may be determined subsequently at the audience analysis site 5 from the data transmitted from the portable memory device 6 which indicates that the device was in the vicinity of the fixed monitoring device 4, and by comparison of the time-stamped codes/signatures transmitted from the portable monitoring device 6 and the time-stamped codes/signatures transmitted from the fixed monitoring device 4.

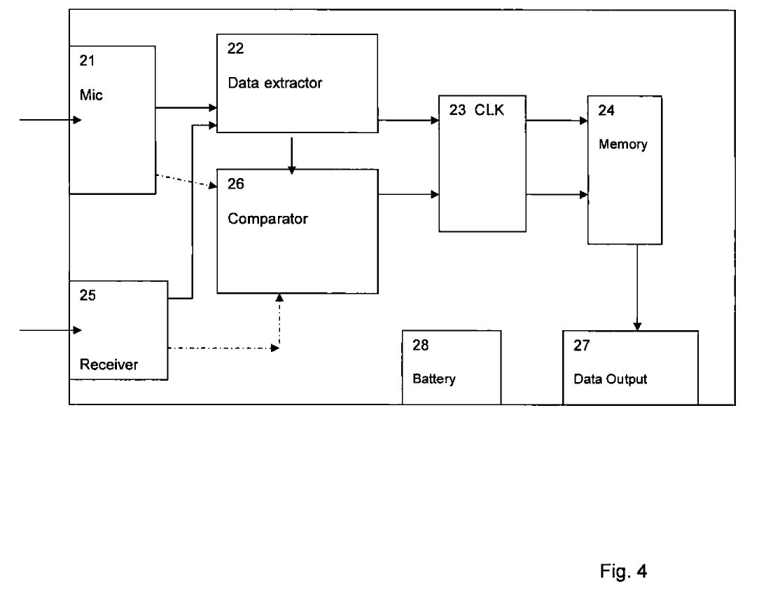

According to another embodiment of the portable monitoring device 6, shown in FIG. 4, a code extractor of the portable monitoring device is arranged to extract a code from the audio signal of the device present signal received from the fixed monitoring device 4, and the comparator 26 is arranged to perform the comparison process by comparing the code extracted from the device present signal with a code extracted from the audio signal of the sound received by the microphone 21. This simplifies the operation of the comparator 26 and helps to reduce power consumption and memory usage. The code extractor for extracting the code from the device present signal may be a code extractor provided in the data extraction means 22 or a separate dedicated code extractor. If no code is present in one of the audio signals received by the microphone 21 and the radio receiver 25, the comparator may perform the comparison by audio matching using the received audio signals, as shown by the dotted lines.

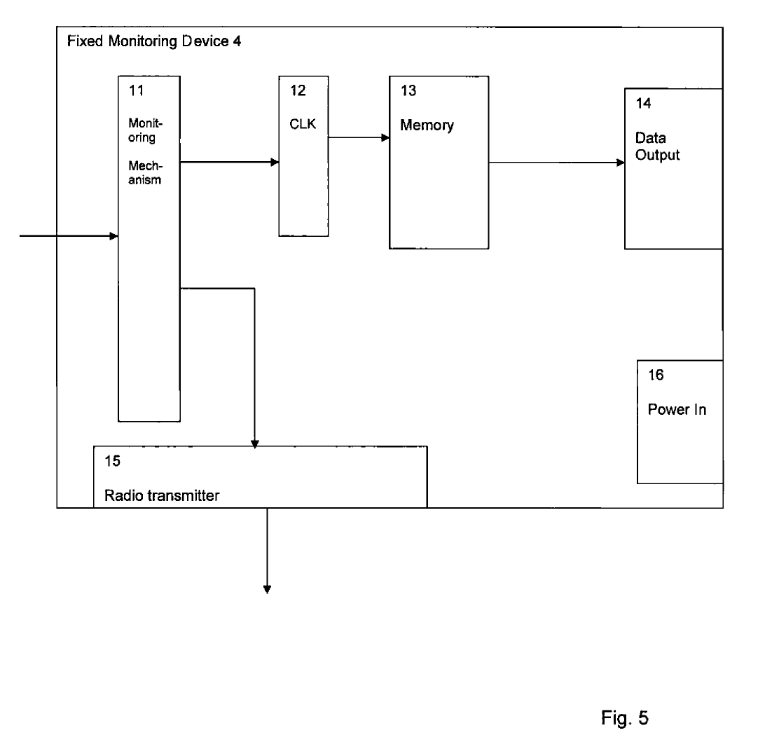

According to another embodiment of the fixed monitoring device 4, the fixed monitoring device 4 may broadcast a signal derived from the audio signal of the received broadcast signal, rather than the audio signal itself. In this regard, it is often undesirable (in some cases illegal) to transmit the actual audio signal over the radio link from the short-range radio transmitter 15 to the receiver 25. The signal derived from the audio signal may be a feature extracted from the audio signal by the code or signature extractor of the monitoring mechanism 11, as shown in FIG. 5. Thus, the transmitted signal derived from the audio signal may be a code extracted from the audio signal by a code extractor of the monitoring mechanism 11 or signatures extracted from the audio signal by a signature extractor of the monitoring mechanism 11.

In the event that the fixed monitoring device 4 transmits a signature or code derived from the audio signal, as opposed to the audio signal itself, the comparator 26 of the portable monitoring device 6 will compare the signature or code with an equivalent signature or code extracted by its signature or code extractor, respectively. In this case, the fixed monitoring devices 4 and the portable monitoring devices 6 are provided with corresponding code extractors for extracting the same code (e.g. CBET code) from the audio signal, and/or corresponding signature extractors for extracting the same signatures from the signal. In this regard, the corresponding signature extractors may extract signatures at the same timings, for example at predetermined times after the occurrence of particular events (such as abrupt signal changes) in the audio signal. Such ‘cue’ based signature extraction is disclosed in U.S. Pat. No. 4,230,990, hereby incorporated by reference in its entirety. The extracted codes or signatures may be compared by the comparator 26.

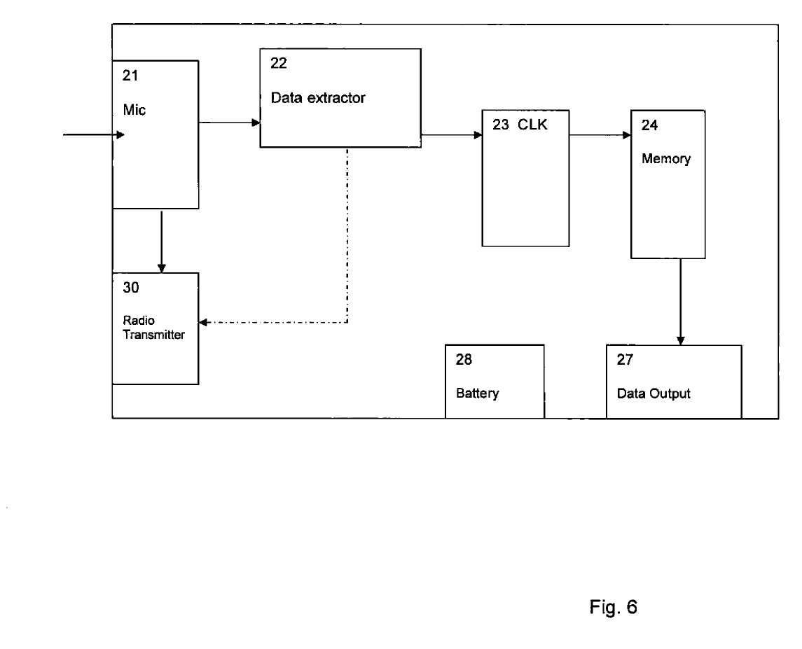

In an alternative embodiment, shown in FIG. 6, the portable monitoring device 6 transmits the device present signal and the fixed monitoring devices 4 receive the device present signal. In other words, the device present signal containing information identifying the portable monitoring device and the audio signal (or a signal derived therefrom, such as an extracted code or signature) of the sound received by the microphone 21 of the portable monitoring device 6 is transmitted in the vicinity of the portable monitoring device 6 using a short-range radio transmitter 30.

The solid line between the microphone 21 and the transmitter 30 indicates the case in which the actual audio signal is transmitted and the dotted line between the data extractor and the microphone 30 indicates the case in which a signal derived from the actual audio signal, such as an extracted code or signature, is transmitted from the transmitter 30.

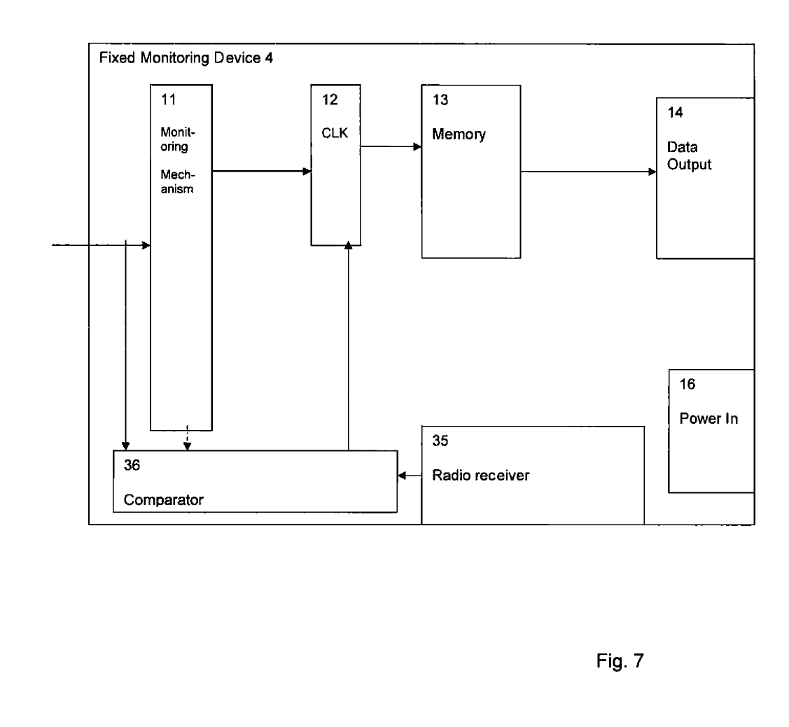

FIG. 7 shows a configuration of a fixed monitoring device 4 for receiving the device present signal from the portable monitoring device 6 of FIG. 6. The fixed monitoring device 4 includes a radio receiver 35 as a communicator instead of the short-range radio transmitter 15 shown in FIG. 3. The radio receiver receives the device present signal from the portable monitoring device and identifies the portable monitoring device from the device identifying information in the audio signal.

The fixed monitoring device further includes a comparator 36 for comparing the audio signal, or signal derived therefrom, received from the portable monitoring device with the audio signal obtained from the broadcast signal received by the television/set top box 3 being monitored. As in the case of the comparator 26 provided in the portable monitoring device 6 of FIG. 3, the comparator 36 may compare the signals by audio matching, for example by comparing the amplitude or frequency variations of the signals.

Alternatively, the comparator 36 may compare extracted codes or signatures of the audio signals. For example, if the portable monitoring device 6 transmits from its transmitter 30 a code or signatures extracted from the audio signal received by its microphone 21, the comparator 36 may compare the received codes/signatures with equivalent codes/signatures extracted from its received broadcast signal by the code/signature extractor of its monitoring mechanism 11 (as indicated by the dotted line in FIG. 7). As another example, if the portable monitoring device 6 transmits its received audio signal from its radio transmitter 30, the monitoring mechanism 11 of the fixed monitoring device may be arranged to extract a code or signatures from this signal, together with an equivalent code or signatures from the broadcast signal received by the TV 3 associated with the fixed monitoring device 4, and the comparator 36 may be arranged to compare these extracted codes/signatures.

Other features of the comparator 36 may be analogous to those outlined above with respect to the comparator 26 of the portable monitoring device.

Thus, the circuitry of the receiver 35 may determine from the device present signal the identity of any portable monitoring devices 6 in the vicinity and whether or not the portable monitoring devices are receiving audio signals. If none of the portable monitoring devices are receiving audio signals, i.e. are not exposed to media programs, then the comparator 36 may be made to discontinue the comparison process. In this way, power consumption and memory usage may be reduced.

Furthermore, if the circuitry of the receiver 35 receives one or more device present signals indicating that one or more portable monitoring devices 6 are in the vicinity of the fixed monitoring device 4, and determines from the signals that at least one of the portable monitoring devices is receiving an audio signal (indicating that it is exposed to a media program), and if the code extractor and/or signature extractor of the monitoring mechanism 11 of the fixed monitoring device is extracting codes (e.g. CBET codes) or signatures from its received broadcast signal, then the comparator 26 may be made to discontinue the comparison process.

In this way, power consumption and memory usage may be reduced. The exposure of a portable monitoring device 6 (and hence member wearing it) to the programs received by a television 3 associated with the fixed monitoring device 4 may still be determined by later comparison at the audience analysis site 5 between the time-stamped codes and/or signatures extracted by the code and/or signature extractors 22 of the portable monitoring devices and the corresponding time-stamped codes and/or signatures extracted by the monitoring mechanism 11 of the fixed monitoring device 4. In particular, the pattern of channel changing over time recorded by the time-stamped codes or signatures will enable it to be determined which portable monitoring device was exposed to the same programs as the fixed television 3 monitored by the fixed monitoring device 4. This will also usually be the case if two portable monitoring devices 6 are in the vicinity of the fixed monitoring device, as the members of the sample household wearing the portable monitoring devices will usually move away from the fixed monitoring device (TV associated with it) at different times, for example to go to the kitchen or bathroom.

As a further alternative, the portable monitoring device 6 may be configured such that if it detects codes and/or signatures in the audio signal of the received broadcast signal using its data extractor 22, it ceases to broadcast the audio from its short-range radio transmitter 30. This has the advantage of reducing occupancy of the radio spectrum and reducing power consumption in the portable monitoring device. A fixed monitoring device 4 that the portable monitoring device 6 is in the vicinity of is thus unable to perform the comparison process using the comparator 36, but continues to extract codes and/or signatures from its received broadcast signal. The exposure of a portable monitoring device 6 to the programs received by a television 3 associated with the fixed monitoring device 4 may be determined subsequently at the audience analysis site 5 from the data transmitted from the portable monitoring device 6 which indicates that the device was in the vicinity of the fixed monitoring device 4, and by comparison of the time-stamped codes/signatures transmitted from the portable monitoring device 6 and the time-stamped codes/signatures transmitted from the fixed monitoring device 4.

In a further embodiment of the invention, an event timing detector may be employed in the fixed 4 and portable 6 monitoring devices instead of a signature extractor. The event timing detector detects the timing of events or cues within the audio signal, but not the nature of the events. In other words, it detects at what timings events (‘cues’) occur but not the details (signatures) of the events themselves. Thus, the event timing detector detects the timings at which events occur in the audio signal, such as that an event occurred ˜100 mS ago. The individual timings detected by the event timing detector cannot be used to identify a program received, but by comparing a number of the timings, whether or not audio signals match can be determined. As events, the event timing detector may be arranged to detect a peak in the rate of change of energy at one frequency, or set of frequencies, relative to another frequency or set of frequencies. Alternatively, it may be arranged to detect a different event such as a peak in amplitude. However, it must be ensured that the detection is accurate enough as not to be unduly disturbed by extraneous noises picked up by the microphone of the portable monitoring device 6.

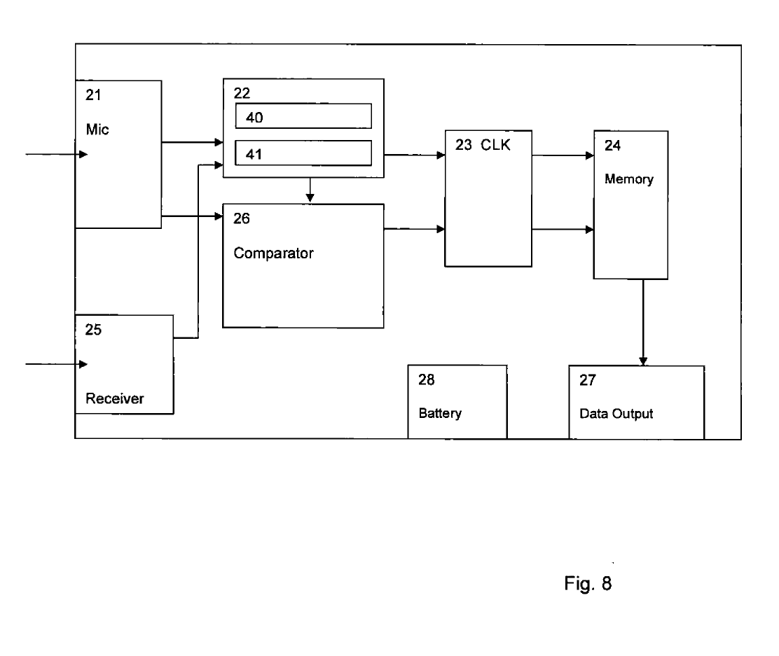

FIG. 8 shows a portable monitoring device 6 in which an event timing detector is employed. As in FIGS. 3 and 4, the portable monitoring device includes a microphone 21, a data extractor 22, a clock 23, a memory 24, a radio receiver 25, a comparator 26, a data output 27 and a battery 28. The data extractor includes a code extractor 40 and an event timing detector 41. The code extractor 40 extracts ancillary codes embedded in the audio signal of sounds received by the microphone 21. These codes may, for example, be CBET codes. The extracted codes are time-stamped by the clock 23 and stored in the memory 24. They may be transmitted from the portable monitoring device via the data output 27.

The event timing detector 41 extracts the timings of events within the audio signal received by the microphone 21. These events may be a peak in the rate of change of energy at one frequency relative to another frequency.

The radio receiver 25 is operable to receive the device present signal broadcast by a fixed monitoring device 4. In this embodiment, the device present signal includes a device identifying signal identifying the fixed monitoring device concerned and a signal containing the timings of events in the audio signal of the broadcast signal received by the fixed monitoring device (which is a signal derived from the audio signal of the received broadcast signal). These timings are extracted by an event timing detector provided in the monitoring mechanism 11 of the fixed monitoring device 4.

The portable monitoring device 6 detects the identity of a fixed monitoring device 4 that the portable monitoring device is in the vicinity of, from the device identifying signal. In addition, the comparator 26 of the portable monitoring device compares the timings of events extracted by the event timing detector 41 with the timings of events contained in the device present signal. The comparator may generate a cumulative score of hits or matches when timings correspond, and may erode or scratch the score when timings do not correspond. In this way, the comparator determines whether or not the audio received by the microphone 21 of the portable monitoring device is the same as the audio of the broadcast signal received by a media device 3 associated with a fixed monitoring device 4. The time stamped results of the comparison are stored in memory 24.

In many jurisdictions, continuous transmission from the fixed monitoring devices 4 would not comply with the relevant rules. In addition, continuous transmission may lead to problems of collision when multiple fixed monitoring devices are provided in a household having multiple media devices (e.g. television sets) to be monitored. The above arrangement, wherein the device present signal includes the timings of events in the audio signal, is advantageous because the device present signal may be transmitted intermittently. Thus, problems of collision and compliance with the relevant rules are overcome. In addition, power consumption may be reduced.

The portable monitoring device of this embodiment may have similar features of discontinuing the comparison or code extraction in particular circumstances as previously described with respect to the portable monitoring devices of FIGS. 3 and 4.

In addition, event timing detectors may also be used in the embodiments wherein the portable monitoring device is provided with a transmitter 30 and the fixed monitoring device is provided with a receiver 35. In this case, the portable monitoring device has an event timing detector for detecting the timings of events within the audio signals received by microphone 21 and transmits these timings as part of the device present signal from transmitter 30. The fixed monitoring device has an event timing detector to detect the timings of events in the audio signal of the broadcast signal received by its associated TV/set-top box 3, and its comparator 36 is arranged to compare the timings detected by the respective event timing detectors.

The fixed monitoring device of the above embodiments may monitor interactive services by using a code extractor to extract codes in the video signal. Alternatively, the monitoring device may utilize software for determining what is happening in the set top box or television. This information may be relayed from the set-top box or television using a wired connection, for example. Alternatively, it may be sent from the set top box or television via a return path back to the broadcaster facility, and then be forwarded from the broadcast facility to the audience analysis site. Such techniques are known.

In the above embodiments, the communication between the portable monitoring device and the fixed monitoring device is performed by means of short-range radio transmissions. However, other forms of transmission of the monitoring device present signal are possible, such as using ultrasonic or infrared, and embodiments of the invention may include portable and fixed monitoring devices having receivers and transmitters for communicating by such means.

According to a still further embodiment of the invention, radio ranging techniques or 3-D radio location are used to determine when a portable monitoring device is in the vicinity of a fixed monitoring device. For performing radio ranging, a time-of-flight measurement, i.e. round trip delay of the radio signal from the fixed monitoring device to the portable monitoring device (or vice versa) could be used. For performing 3-D radio location, radio direction finding techniques to triangulate the position of the portable monitoring device with respect to a fixed monitoring device could be used.

A further embodiment of the invention provides a portable monitoring device for use in an audience measurement system for monitoring programs viewed and/or listened to by one or more members of a sample household, the portable monitoring device comprising: a receiver for receiving sound of a program emitted by any nearby media device; a data extractor for extracting data from the received sound to enable a program and/or station to be identified; and a communicator for transmitting a device present signal to a fixed monitoring device such that it may be detected at the fixed monitoring device when the portable monitoring device is in the vicinity of the fixed monitoring device.

A still further embodiment provides a fixed monitoring device for use in an audience measurement system for monitoring programs viewed and/or listened to by one or more members of a sample household, the fixed monitoring device being associated with a particular media device, in the household's home, wherein the fixed monitoring device comprises: a monitoring mechanism for monitoring a received broadcast signal and/or a state of the media device to extract information enabling a received program and/or station to be identified; and a communicator for detecting a device present signal transmitted from a portable monitoring device, to thereby determine that the portable monitoring device is in the vicinity of the fixed monitoring device.

Although the invention has been described with respect to specific embodiments for a complete and clear disclosure, the appended claims are not to be thus limited but are to be construed as embodying suitable modifications and equivalents that may occur to one skilled in the art and which fairly fall within the basic teaching herein set forth.

We claim:

1. An audience measurement system for monitoring programs, comprising:
a fixed monitoring device and a portable monitoring device, wherein the fixed monitoring device is associated with a particular media device in a household's home, and comprises:
a monitoring mechanism for monitoring a received broadcast signal or a state of the media device to extract information enabling a received program or station to be identified; and
a first communicator for communicating with the portable monitoring device, the portable monitoring device comprising:
a receiver for receiving sound of a program emitted by at least one nearby media device;
a data extractor for extracting data from the received sound to enable a program and/or station to be identified; and
a second communicator for communicating with the fixed monitoring device; wherein either the first or the second communicator is operable to transmit a device present signal in the vicinity of its respective monitoring device, and the second or the first communicator is operable to detect the present signal, such that the first or second communicator is operable to detect when the portable monitoring device is in the vicinity of the fixed monitoring device.

2. The system of claim 1, wherein the first or second communicator is operable to transmit device identifying information as at least a part of the device present signal.

3. The system of claim 1, wherein the first or the second communicator includes a transmitter for transmitting an audio signal, or a signal derived therefrom, of the received broadcast signal or of the received sound, respectively, as at least a part of the device present signal, and the second or the first communicator includes a receiver for receiving the audio signal or the signal derived therefrom.

4. The system of claim 3, wherein the monitoring device having the receiver further includes a comparator for comparing the audio signal, or the signal derived therefrom, received from the communicator of the other monitoring device, with the audio signal, or a signal derived therefrom, of its received program sound or received broadcast signal, respectively, to determine whether the audio signals correspond.

5. The system of claim 4, wherein the comparator is operable to compare codes and/or signatures extracted from the audio signals by code and/or signature extractors, respectively.

6. The system of claim 4, wherein the comparator is operable to compare event timings extracted from the audio signals by an event timing detector.

7. The system of claim 4, wherein the comparator is operable to perform the comparison only when it is determined that the portable monitoring device is in the vicinity of the fixed monitoring device and that the particular media device monitored by the fixed monitoring device is switched on.

8. The system of claim 1, wherein the data extractor of the portable monitoring device includes a code extractor for extracting a code from the audio signal of the received sound and/or a signature extractor for extracting audio signatures from the audio signal of the received sound.

9. The system of claim 1, wherein the monitoring mechanism of the fixed monitoring device includes a code extractor for extracting a code embedded in the received broadcast signal and/or a signature extractor for extracting a signature from the received broadcast signal.

10. The system of claim 9, wherein the code extractor is arranged to extract a code embedded in the audio signal of the received broadcast signal and/or the signature extractor is arranged to extract a signature from the audio signal of the received broadcast signal.

11. An audience measurement method for monitoring programs viewed and/or listened to by a member of a sample household using a fixed monitoring device associated with a particular media device in the member's home and a portable monitoring device which may be carried by the member, the method comprising:
monitoring a received broadcast signal and/or a state of the particular media device, using the fixed monitoring device, to extract information enabling a received program and/or station to be identified;
receiving sound of a program emitted by at least one nearby media device using the portable monitoring device;
extracting data from the received sound to enable a received program and/or station to be identified;
transmitting a device present signal from the fixed monitoring device or the portable monitoring device in the vicinity of the fixed monitoring device; and
detecting the device present signal at the other of the fixed monitoring device and the portable monitoring device so as to detect when the portable monitoring device is in the vicinity of the fixed monitoring device.

12. The method of claim 11, wherein the device present signal includes device identifying information.

13. The method of claim 11, wherein the device present signal includes an audio signal, or a signal derived therefrom, of the received broadcast signal or of the received sound.

14. The method of claim 13, further including extracting a code and/or a signature from the device present signal when the device present signal is detected.

15. The method of claim 11, wherein the received broadcast signal is monitored by extracting a code and/or signature from the signal.

16. The method of claim 11, wherein the extracting data from the received sound includes extracting a code embedded in the audio signal of the received sound and/or extracting a signature from the audio signal of the received sound.

17. The method of claim 11, further comprising:
comparing, at the other of the fixed monitoring device and the portable monitoring device, the audio signal, or the signal derived therefrom, with the audio signal of the received broadcast signal or of the received program sound, respectively.

18. The method of claim 17, wherein the comparison is performed using codes, extracted from the audio signals and/or using signatures extracted from the audio signals.

19. The method of claim 17, wherein the comparison is performed using the timings of events detected in the audio signal of the broadcast signal received by the fixed monitoring device and the timings of events detected in the audio signal of the sound received by the portable monitoring device.

20. A fixed monitoring device for use in an audience measurement system for monitoring programs viewed and/or listened to by one or more members of a sample household, the fixed monitoring device being associated with a particular media device, in the household's home, wherein the fixed monitoring device comprises:
a monitoring mechanism for monitoring a received broadcast signal and/or a state of the media device to extract information enabling a received program and/or station to be identified; and
a communicator for transmitting a device present signal in the vicinity of the fixed monitoring device, the device present signal being receivable by a portable monitoring device.

21. The device of claim 20, wherein the monitoring mechanism includes at least one of a code extractor for extracting a code from the received broadcast signal, a signature extractor for extracting a signature from the received broadcast signal, and a media device tuning detector for detecting a frequency to which the media device is tuned.

22. The device of claim 20, wherein the communicator is operable to transmit device identifying information as at least a part of the device present signal.

23. The device of claim 20, wherein the communicator is operable to transmit an audio signal, or a signal derived therefrom, of the received broadcast signal, as at least a part of the device present signal.

24. The device of claim 23, wherein the signal derived from the audio signal is the timing of events within the audio signal.

25. A portable monitoring device for use in an audience measurement system for monitoring programs comprising:
a receiver for receiving sound of a program emitted by any nearby media device;
a data extractor for extracting data from the received sound to enable a program and/or station to be identified; and
a communicator for detecting a device present signal from a fixed monitoring device when the portable monitoring device is in the vicinity of the fixed monitoring device.

26. The device of claim 25, further comprising a comparator for comparing an audio signal of the device present signal with an audio signal of the received sound, so as to determine whether the portable monitoring device is exposed to substantially the same program as the fixed monitoring device.

27. The device of claim 26, wherein the portable monitoring device is operable to determine from the received device present signal whether a media device associated with the fixed monitoring device is switched on, and to control the comparator to perform the comparison when it is determined that the said media device is switched on.

28. The device of claim 26, wherein the portable monitoring device is operable to control the comparator to cease performing the comparison if it is determined that the device is in the vicinity of the fixed monitoring device and the data extractor is extracting data from the received sound.

29. The device of claim 25, wherein the data extractor includes at least one of a code extractor for extracting a code from the audio signal of the received sound, and a signature extractor for extracting a signature or an event timing detector for detecting the timing of an event from the audio signal of the received sound.
